(19) United States
(12) Patent Application Publication
(10) Pub. No.: US 2012/0171965 A1
(43) Pub. Date: Jul. 5, 2012

(54) Anti-Interference and Anti-Piracy Methods For Improving Stability of RF Signals for Two-Way Remote Control System

(76) Inventor: Chu-Ping Shen, Taipei Hsien (TW)

(21) Appl. No.: 12/983,188

(22) Filed: Dec. 31, 2010

(51) Int. Cl. H04B 1/00

(52) U.S. Cl. 455/63.1

(57) ABSTRACT

A remote control system and its anti-interference and anti-piracy methods for improved stability of RF signals; it comprises: a HHCU and a main unit for two-way wireless transmission; its functions include: optimized channel can be searched automatically in signal transmission while confirming the feedback after implementation; multiple interactive encryption, multiple RF transmission receiving and group tag technologies are adopted to realize multiple efficacies such as: quick response, resistance to interference and piracy and improvement of RF signal stability. Furthermore, the system employees methods for multiple function module and automatic adjustment of power output for RF signal that minimize power consumption and provides more versatile use of the system.

### BACKGROUND OF INVENTION

1. Field of the Invention

The present invention relates to an improved two-way remote control system, and more particularly to an innovative one which is designed with anti-interference and anti-piracy functions for improving the stability of radio frequency (RF) signals.

2. Description of Related Art

Wireless remote controllers are widely used in a broad range of applications, such as: household appliances, shutters of garages and vehicle or motorcycle theft-proof equipments, by means of remote control for the benefit of users. For instance, the vehicle or motorcycle theft-proof equipments are intended for protecting the vehicles or motorcycles against any theft, conversely the thieves will make every attempt to interrupt, decode or receive and copy the wireless signals. Thus, the security performance of theft-proof equipments is of utmost significance.

A common wireless remote controller consists of a transmitter and a receiver that are implemented only by a single-power, single-frequency RF device, namely, a transmitter capable of only transmitting data by a fixed channel is set onto a remote controller, and a preset receiver capable of only receiving data by a fixed channel is set onto a vehicle, thereby realizing RF remote-controlled operation; yet, the aforementioned single-power, single-frequency RE device has the following shortcomings:

(1) Notwithstanding the simple construction of single-power, single-frequency RE device, its poorer remote control functions make it vulnerable to ambient interference, especially during data receiving by the receiver.

(2) in the case of adjacent channel interference, e.g.: during RF remote-controlled operation by dozens of vehicles in the same parking lot, the receiver subjecting to interference cannot receive data efficiently, or may even receive incorrect data in an disorderly way.

(3) As signals are transmitted by the remote controllers at a fixed frequency, the targeted objects may be stolen very easily once the remote controllers are pirated, leading to extremely low security and confidentiality.

(4) The operating process of conventional remote control system is: the remote controller transmits RF signals to the main unit by pressing the button of remote controller, then the main unit implements the required actions and transmits the contents to the remote controller via RE signals; after receiving the contents from the main unit, the remote controller displays them by means of LCD, alarming, vibration and back light 0/P. This cannot be implemented smoothly in case the signals are not received normally by any part in the transmission process arising from any reason (e.g.: ambient interference).

In addition, there are generally two types of remote control system available in the automobile market and they are keyless entry function remote control system and alarm function remote control system. Each of the mentioned remote control may include an additional function, such as remote start function, with the system. The main difference between keyless entry function and alarm function remote control system is that in the keyless entry function remote control system only when any of the function key is pressed the system will execute corresponding function; once the system has executed the corresponding function it enters into sleep mode until any of the function key is pressed once again. When the system is in sleep mode it does not need to keep a communication link with the main unit in the car. On the other hand, in the alarm function remote control system, once the system has executed a function corresponding to a function key pressed and then enters into sleep mode, the system needs to be “awake” constantly in a pre-set time frame to check with the main unit in the car for any abnormal activities detected.
A. Keyless entry function remote control system generally including the following functions: 1. lock, 2. unlock and 3. trunk-open (the system only operates when the one of the function key is pressed on a remote controller transmitter). The battery life for this system usually last for over a year. Alarm function remote control system generally including the following functions: 1. alarm/lock, 2. disarm unlock, 3. trunk-open and 4. main unit trigger, including door, trunk, hood and shock triggers (the system operates when one of the function key is pressed on a remote controller transmitter and any other time when the key is not pressed, typically, every few seconds, to check with the main unit for any abnormal activities detected). The battery life for this system usually last for about four months.
B. Keyless entry and remote start function remote control system generally including the following functions: 1. lock, 2. unlock, 3. trunk-open, 4. start-engine and 5. stop-engine (the system only operates when the one of the function key is pressed on a remote controller transmitter). The battery, life for this system usually last for over a year.
D. Remote start and alarm function remote control system generally including the following functions: 1, alarm/lock, 2. disarm/unlock, 3. trunk-open and 4. start-engine and 5. main unit trigger, including door, trunk, hood and shock triggers (the system operates when one of the function key is pressed on a remote controller transmitter and any other time when the key is not pressed, typically, every few seconds, to check with the main unit for any abnormal activities detected). The battery life for this system usually last for about four months.

These four main remote control systems because of their difference in functionalities must be used separately and for the users it is a hassle both in use and storage of the systems.

Furthermore, another shortcoming of the remote control unit systems available in the market is that it only comes with a standard RF output power. To explain this shortcoming: if a remote control transmitter is capable of transmitting RF signal up to 100M. However, regardless the distance between the transmitter and the receiver, RF output power is fixed at a output rate for 100M, whether the distance is 10 or 100M. This is a waste of battery power and sometime when the output power to the distance ratio is too great it will cause unstable remote control action.

In view of above-specified shortcomings of conventional wireless remote control system, some improvements are required to resolve the influential factors to operational convenience and security.

### SUMMARY OF THE INVENTION

The primary objective of the present invention is to provide a remote control system and its anti-interference and anti-piracy methods for improved stability of RF signals, whereby optimized channel can be selected in transmission of functional signals, so as to minimize the interference and transmit signals stably while confirming the feedback of implemented functions.

The second objective of the present invention is to provide a remote control system and its anti-interference and anti-piracy methods for improved stability of RF signals, whereby signal transmission between HHCU and main unit can be implemented with stronger anti-piracy functions to improve the overall security and confidentiality.

The third objective of the present invention is to provide a remote control system and its anti-interference and anti-piracy methods for improved stability of RF signals, whereby HHCU can be operated with quicker response, lower power consumption and stronger anti-interference functions.

The fourth objective of the present invention is to provide a remote control system and its anti-interference and anti-piracy methods for improved stability of RF signals, whereby the remote control system can be operated more stably and efficiently.

The fifth objective of the present invention is to provide a remote control system and its anti-interference and anti-piracy methods for improved stability of RF signals, whereby the remote control system can automatically switch to multiple function module remote control system with power saving feature.

The sixth objective of the present invention is to provide a remote control system and its anti-interference and anti-piracy methods for improved stability of RF signals, whereby the remote control system can automatically adjust RF signal output power to minimize power usage.

The remote control system of the present invention comprises: a main unit and a handheld remote control unit (HHCU); of which, the main unit is mounted onto the vehicle for two-way wireless transmission to receive the required functional signals, implement the respective functions and send feedback signals; it consists of: a control unit, including: central processing unit (CPU), a ROM, a RAM and a EEPROM; a transmitting-receiving unit (TRU), mounted onto the vehicle for transmitting and receiving signals; the control unit is set to enable (TRU) to automatically search the interference-minimum frequency; the HHCU is used to send encryption signals and permit the main unit to perform multiple functions within effective range, then receive the feedback signals from the main unit and display the implementation status after decryption; it consists of: a control unit, including: a CPU, a ROM, a RAM and a EEPROM; a TRX module, which mates automatically frequency with TRU on the vehicle.

Said remote control system is also designed to encompass: anti-interference, anti-piracy methods for improving the stability of RF signals; of which:

As for the anti-interference method, the HHCU is used to automatically search and select the optimized channel (interference-minimum channel) during transmission of functional signals, so as to prevent signal interference that may lead to failure of receiving functional signals by the main unit; moreover, after receiving the functional signals sent by the HHCU, the main unit will implement immediately the required functions and feed back signals of confirmation.

As for anti-piracy method, both the HHCU and main unit transmit various signals by using interactive encryption technologies to realize high level of anti-piracy efficacies.

Next, a group tag is additionally provided to implement signal transmission in sequence between the HHCU and main unit depending on absolute locations, so the HHCU can be operated with quicker response, lower power consumption and stronger anti-interference functions.

As for the method for improving the stability of RF signals, a multiple RF transmission receiving technology is incorporated into the HHCU, such that it can send actively RF signals of preset number to rebuild a communication channel for highly stable signal transmission in the case of failure of HHCU.

To achieve the system automatically switch to multiple function module remote control system with power saving feature, a module ID is included in the HHCU and the main unit. When the HHCU communicates with the main unit, the main unit sends the module ID to the HHCU and then the HHCU automatically switch to the module corresponding to the module ID received.

To achieve the remote control system and its anti-interference and anti-piracy methods for improved stability of RF signals, whereby the remote control system can automatically adjust RE signal output power to minimize power usage, a power-distance adjustment feature is included in the HHCU. When in close range, the HHCU transmits low power RF signals; when in long range, the HHCU transmits high power RE signals to minimize power usage and to stabilize signals transmitted.

The features and the efficacies of the present invention are described below with reference to the accompanying drawings:

### BRIEF DESCRIPTION OF THE DRAWINGS

FIG. 1: a block chart of a preferred embodiment of the present invention;

FIG. 2: a schematic view of the main unit is circuit structure and functions of a preferred embodiment of the present invention;

FIG. 3: a schematic diagram of the HHCU of a preferred embodiment of the present invention;

FIG. 4: a frequency band diagram of a preferred embodiment of the present invention;

FIG. 5: a flow process chart of a preferred embodiment of the present invention showing the session frequency between the main unit and HHCU;

FIG. 6: a process chart of a preferred embodiment of the present invention showing interactive encryption between the main unit and HHCU;

FIG. 7: a process chart of a preferred embodiment of the present invention showing multiple RF transmission receiving technology between the main unit and HHCU;

FIG. 8: a schematic view of a preferred embodiment of the present invention showing a group tag encoding technology for RE transmission FIG. 9:

### DETAILED DESCRIPTION OF THE INVENTION

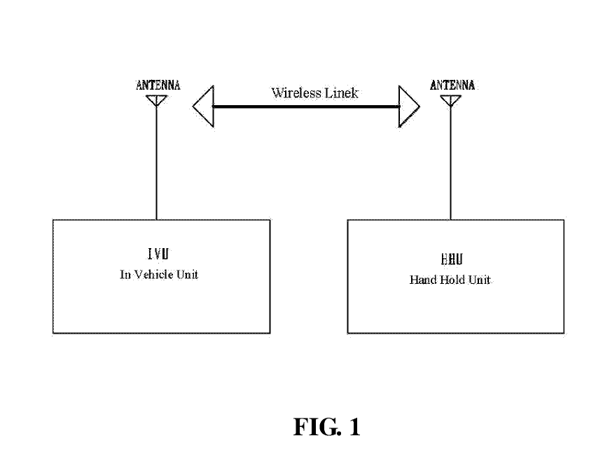

Referring to FIG. 1 of present invention—a block chart of a preferred embodiment of the present invention, wherein the remote control system comprises: a main unit 1 and a HHCU 2.

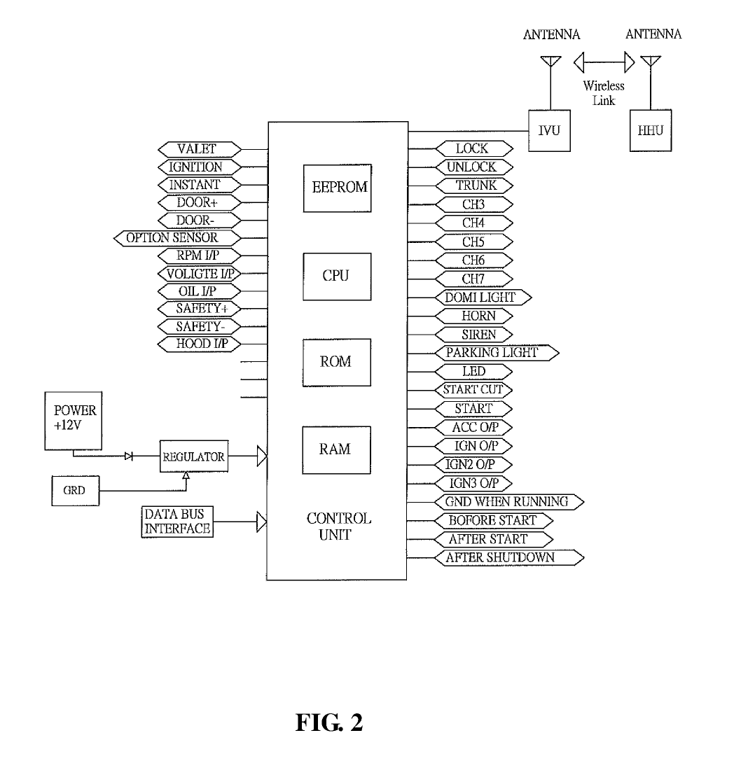

Referring also to FIG. 2 of present invention—a schematic view of the main unit is circuit structure and functions of a preferred embodiment of the present invention, wherein the main unit 1 comprises: a control unit 10, receiver unit 11, input 12, output 13, power regulator 14 and data bus interface 15 mounted onto the vehicle; of which the control unit 10, a key to the main unit 1, also comprises: a CPU 101 with logic calculation function, a ROM 102 for storing program commands, a RAM 103 for storing program data and an EEPROM 104 for storing the program characteristics; TRU 11 set on the vehicle, which is available with two-way wireless transmission functions, is used to receive and transmit the signals between the main unit 1 and HHCU 2, and also search optimized channel via setting of the control unit 10; as shown in the figure, the input 12 generally consists of; voltage 1/P, ignition I/P, instantaneous I/P, door I/P, option I/P, RPM I/P, oil detection I/P, safety I/P, hood I/P, parking brake I/P, diesel water I/P and brake depress VP; and many settings from the main unit 1 are implemented by the voltage I/P and ignition I/P; moreover, the emergency I/P, door VP and option I/P functions refer to the alarming functions subjecting to the detectors triggered by the alarm; that's to say, when the alarm is under a theft-proof state and any action is detected by the detector, the alarm will give a siren, and TRU 11 on the vehicle will transmit the intruded signals to the HHCU 2; RPM I/P, oil detection I/P, safety UP, hood VP, parking brake I/P, diesel water I/P and brake depress I/P refer to the remote control functions subjecting to the detectors, so remote startup of engine cannot be finished smoothly in the case of failure of any detector.

As shown in the figure, the output 13 generally consists of: lock O/P, unlock O/P, trunk O/P, parking light O/P, CH3˜7 O/P, horn O/P, siren O/P, LED O/P, start cut O/P, start O/P, ignition O/P, ACC O/P, ignition#2 O/P, ignition#3 O/P, before start, after start and after shutdown.

Said lock O/P, unlock O/P, trunk O/P, parking light O/P, CH3˜7 O/P, horn O/P, siren O/P, LED O/P and start cut O/P cannot be accessed by alarming or keyless functions; these outputs depend on the alarming response of the alarm of the main unit 1 and the operating call of the HHCU 2; for instance, when the HHCU 2 is operated for theft-proof purpose, the alarm will access the theft-proof functions, whilst the door is locked to start cut O/P and make the parking light flash one time; in such case, if the door is still open, the door unlock/shutdown I/P will be activated, signaling the system to trigger the alarm for giving a siren, a parking light flashing or horn hoot; besides, if said alarm is in a preset start state, the horn hoot is activated, otherwise not activated.

Additionally, start O/P, ignition O/P, ACC O/P, before start, after start, after shutdown and LED O/P are used by remote-control start functions; these functional outputs depend on the remote start status and calling of HHCU 2, e.g.: if the remote start status is set into RPM start, and once the calling of HHCU 2 is started, the system will firstly check if safety VP, hood I/P, parking brake I/P and brake depress I/P are in shutdown state; if yes, the system will send ignition and start outputs, then the system will check automatically if RPM start is normal; if yes, the remote start is successful, and the system transmits a start signal to the HHCU 2, with the remaining outputs operated by the program of CPU 101.

During the start operation, the system continues to check if safety I/P, hood I/P, parking brake VP and brake depress FP are in shutdown state, and if the RPM is normal. In case any input item is not normal during the operation, the system will immediately stop and then send the information of this item to the HHCU 2. For example, any negligence of the user in manual braking will lead to failure of remote start. In such case, the system will immediately stop and then send the information to the HHCU 2, reminding the users of pulling up the manual brake. If the hood is opened when the engine is in operation after successful remote start, the system will immediately stop and then send the information to the HHCU reminding the user of the reason.

The power supply of the main unit 1 is from automotive battery with 12V DC. Due to the variation of load, 12V voltage is not stable, and 5V stable power is required by CPU 101 of the main unit 1 and RF circuit of TRU 11 set on the vehicle. So, the main unit 1 is designed with a power regulator 14 for supplying stable power to CPU 101 and RF circuit of TRU 11 set on the vehicle.

Most of ex-factory vehicles are provided with a data port, which is linked to onboard computer via a data transmission interface, so the main unit 1 is also provided with a data transmission interface 15.

The HHCU 2 can be used manually within its effective range, enabling the main unit 1 to implement the functions such as: theft-proof activation or releasing, trunk or engine start/shutdown; two-way transmission is realized between the HHCU 2 and main unit 1 via wireless linking. For example, when the user presses the functional key of the HHCU 2 requiring the main unit 1 to lock door, the main unit 1 will implement door locking immediately after receiving the command signals from the HHCU 2, and also feed back the confirmation signal to the HHCU 2.

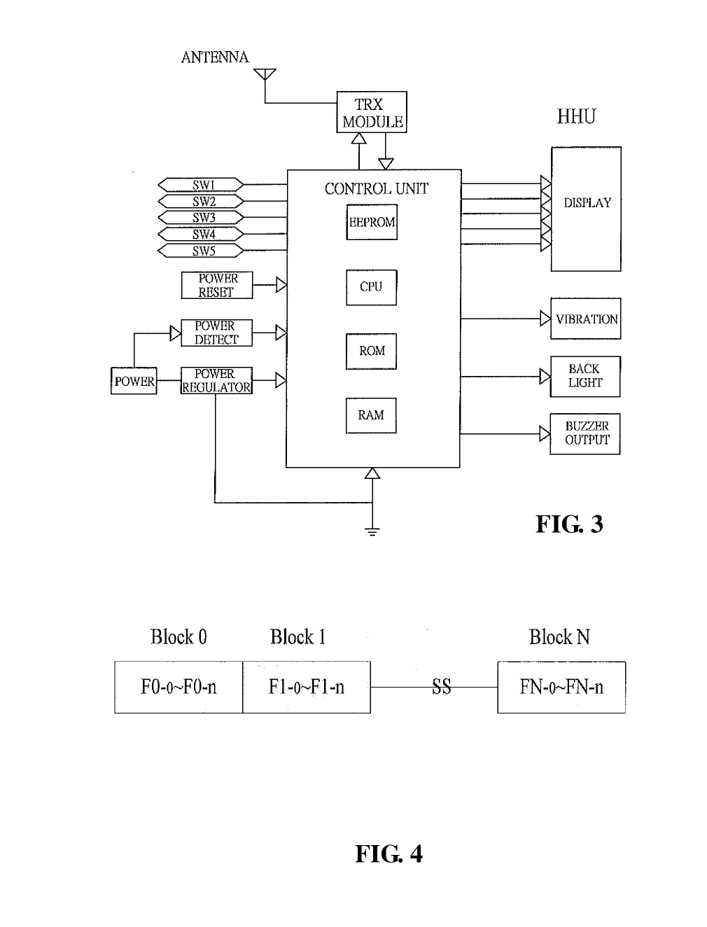

Referring to FIG. 3 of present invention—a schematic diagram of the HHCU of a preferred embodiment of the present invention, wherein the HHCU 2 comprises:

A control unit 20, also comprising: a CPU 201 with logic calculation function, a ROM 202 for storing program commands, a RAM 203 for storing program data and an EEPROM 204 for storing the program characteristics;

A TRX module 21, which is available with two-way wireless transmission functions, is used to receive and transmit the signals between the main unit 1 and HHCU 2;

Multiple inputs 22, used for remote calling of various functions by the HHCU 2, including: SW 1 for door locking, SW 2 for door unlocking, SW 3 for trunk opening, SW 4 for start and SW 5 for the program status, all of which can be changed freely with respect to their functional sequences;

Multiple outputs 23, used for remote calling of various functions by the HHCU 2, including: LCD O/P, alarm O/P, vibration O/P and back light O/P, of which LCD O/P is used to transmit and display the system state, e.g. either operation or shutdown can be visualized from LCD, and any real-time failure leading to shutdown can be acquired from LCD. The alarm is used for reminding the users of the status, e.g.: when door lock or unlock is triggered, the alarm will ring or continue to ring for 10˜15 SEC (similar to incoming calls of mobile phone). The vibration output is only used for viberational prompting, unlike acoustic prompting of the alarm. The back light output enables the user to visualize clearly the status via back light of the LCD.

A power regulator 24 and power detector 25, of which the power regulator 24 with boosting function can provide sufficient voltage, since the main power supply of the HHCU 2 is 1.5V DC, and CPU 201 and RF of TRX module 21 require over 3V voltage.

Battery replacement is a key issue since all functions of the HHCU 2 are implemented through the battery power. An auto theft-proof remote controller is generally equipped with a battery detector, which will detect the power and remind the users of replacing battery in the case of lower power. In consideration of different discharge performance, some batteries could be used continuously under lower power (possibly 1 week), and some others may be used up quickly (possibly 1 or 2 days). In such case, the users have to replace the battery immediately, otherwise the vehicles cannot be started. As a most important part of the present invention, the HHCU 2 is designed into a two-way, multifunctional and intelligent remote controller that can notify the users of the accurate power supply state, but also extend the service life of battery and provide the users with sufficient time of replacing or charging the battery.

FIG. 4 of present invention depicts a frequency band diagram of a preferred embodiment of the present invention. To ensure stable and efficient signal transmission between the main unit 1 and HHCU 2 under various frequency interferences, an auto-searching method is specifically adopted to find out the optimized interference-minimum frequency for this purpose; according to this method, the control unit 10 of the main unit 1 is set in such a way that onboard TRU 11 has the function of automatically searching frequency and transmitting data; by selecting any RF band, several frequencies therein are cut into “n” blocks of the same size (this parameter can be set freely), such that every block contains the frequencies of the same quantity. With this design, the onboard TRU 11 will, at a fixed interval, conduct intensity calculation and weighting of the frequencies within all blocks, so as to offer a mating frequency for TRX module 21 of the HHCU 2; in case where all frequencies in the first block are interfered, onboard receiver unit 11 will automatically switch to the next block for searching the minimum calculated weight, until the frequencies of all blocks are matched, and the minimum weighted value is fed back to the HHCU 2.

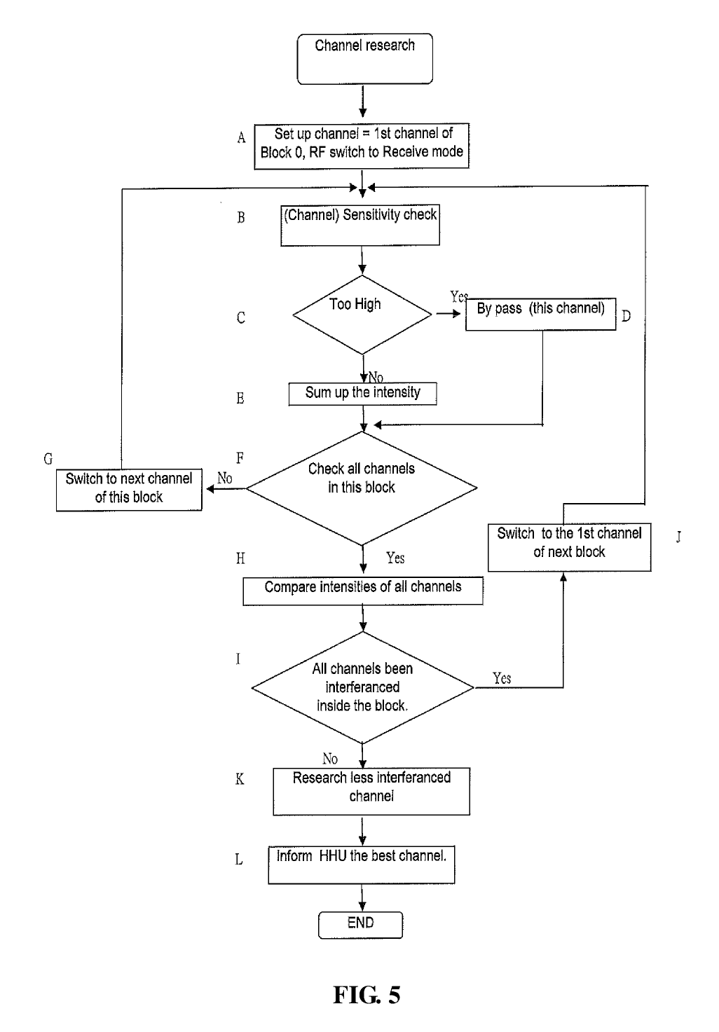

Referring also to FIG. 5 of present invention—a flow process chart of a preferred embodiment of the present invention showing the session frequency between the main unit and HHCU, with the processes shown below:
Process A: starting from the first frequency of the first block, RF is turned to receiving frequency for detecting the intensity of the channel;
Process B: read the intensity of the channel;
Process C: this channel is unavailable in the case of extremely, strong intensity;
Process D: this channel is unavailable;
Process E: calculate the intensity of frequency by weighted scoring;
Process F: check if the frequencies in the block are detected;
Process G: skip to the next frequency in the block for repeating process B;
Process H: all frequencies in this block are detected, then the weighted scores of all frequencies are compared;
Process I: check if the frequencies in this block are interfered;
Process J: skip to the first frequency in next block for repeating process B;
Process K: compare to obtain interference-minimum frequency;
Process L: notify the HHCU of changing into optimized channel (notify by the previous optimized frequency plus back-up frequency).

With this design, the remote control system of the present invention has a longer and more stable transmission distance, whilst the frequencies in the blocks with little interference can be used for signal transmission, helping to prevent piracy with the flexible frequency.

A back-up channel is designed in the present invention to ensure frequency synchronization between the main unit 1 and HHCU 2. This back-up channel is a channel with fixed frequency, which is started in the following cases:

1. When the signals cannot be received normally by the optimized frequency;

2. When the signals cannot be transmitted or received normally die to frequency synchronization between the main unit 1 and HHCU 2.

In either of the aforementioned cases, it is required to switch to the back-up channel immediately, so as to transmit the contents of optimized frequency while the frequencies of the main unit 1 and HHCU 2 are synchronized.

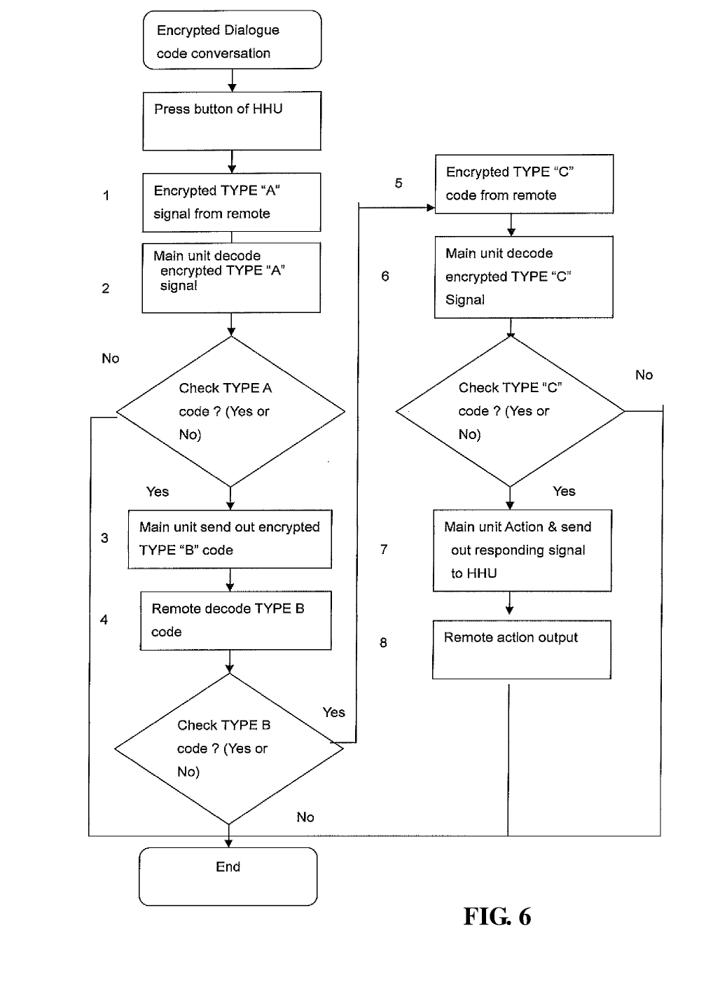

FIG. 6 of present invention depicts a process chart of a preferred embodiment of the present invention showing interactive encryption between the main unit and HHCU; in addition to the method of searching optimized frequency for effective signal transmission with lower interference, an innovative, interactive encryption technology is applied to realize better anti-piracy efficacies in the following steps:
Step 1. (a)“X” in the figure indicates the “number of multiple polling” in the multiple RF transmission receiving technology; this parameter can be freely adjusted by the HHCU 2, a bigger number of polling means higher stability.
   (b) “TYPEA” encryption signal: the HHCU 2 enables logic operation of the data via CPU 201 (which is intended to be sent to the main unit 1), and then sends to the main unit 1 after encryption by means of “TYPEA”.
Step 2. The main unit 1 enables decryption of TYPEA″ encryption signal after logic operation through CPU 101, and then makes sure if the encryption signal is valid and correct; if yes, the signal is resumed to the data intended to be sent by the HHCU 2 to the main unit 1; otherwise the signal is invalid, and the session is ended.
Step 3. “TYPEB” encryption signal: the main unit 1 enables logic operation of the data via CPU 101 (which is intended to be sent to the HHCU 2), and then sends to the HHCU 2 after encryption by means of “TYPEB”.
Step 4. The HHCU 2 enables decryption of “TYPEB” encryption signal after logic operation through CPU 201, and then makes sure if the encryption signal is valid and correct; if yes, the signal is resumed to the data intended to be sent by the main unit 1 to the HHCU otherwise the signal is invalid, and the session is ended.
Step 5. (a) in the figure indicates the “number of multiple polling” in the multiple RF transmission receiving technology; this parameter can be freely adjusted by the HHCU 2, a bigger number of polling means higher stability.
   (b) “TYPEC” encryption signal: the HHCU 2 enables logic operation of the data via CPU 201 (which is intended to be sent to the main unit 1), and then sends to the main unit 1 after encryption by means of “TYPEC”.
Step 6. The main unit 1 enables decryption of “TYPEC” encryption signal after logic operation through CPU 101, and then makes sure if the encryption signal is valid and correct; if yes, the signal is resumed to the data intended to be sent by the HHCU 2 to the main unit 1; otherwise the signal is invalid, and the session is ended.
Step 7. In such case, the main unit 1 has obtained correct signals and implemented the functions from the HHCU 2, and also sent back its status to the HHCU 2.
Step 8. The HHCU 2 displays the status of the main unit 1 onto relevant parts (e.g.: LCD, buzzer, motor).

According to said processes, the operating procedures are as follow: when the user presses any functional key of the HHCU 2, a parameter “A” will be generated randomly by the HHCU 2 via CPU 201, then encrypted and added to the signal sent firstly, namely, “TYPEA” signal; the main unit 1 receives and then decrypts the “TYPEA” signals via CPU 101 according to parameter “A”; then a parameter “B” is generated randomly by the main unit 1 via. CPU 101, then encrypted and added to the signal fed back firstly, namely, “TYPEB” signal; the HHCU 2 receives and then decrypts “TYPEB” signal via CPU 201 according to parameter “B”, which is then encrypted and added to the signal sent secondly, namely, “TYPEC” signal; the main unit 1 receives and then decrypts “TYPEC” signal via CPU 101 according to parameter “B”, of which the decrypted signal refers to the functional action to be implemented by the main unit 1 as required by the HHCU 2; after completion of implementation, the main unit 1 sends back to the HHCU 2 the signal fed back secondly, notifying the user of the completed implementation of the required functions. The core of this interactive process is that, multiple encryptions/decryptions of parameters “A”, “B” are required between the HHCU 2 and main unit 1, and parameter “B” in “TYPEC” signal sent by the HHCU 2 is decided randomly by CPU 101 of the main unit 1, so copying simply the signal of the HHCU 2 cannot implement correctly multiple encryption/decryption processes, leading to failure of receiving valid signal by the remote control system.

The following is a description of the encryption/decryption processes of “TYPEA”, “TYPEB” and “TYPEC” signals:

“TYPEA” encryption process: parameter “A” is generated randomly by a random generator contained in CPU 201, and converted by the HHCU 2 into encryption signal and transmitted to the main unit 1.

“TYPEA” decryption process: the main unit 1 receives and converts the parameter “A” into original signal, and then terminates this operation if the signal is invalid after decryption.

“TYPEB” encryption process: parameter “B” is generated randomly by a random generator contained in CPU 101 and stored into RAM 103; the main unit 1 converts the parameter into encryption signal, and transmits to the HHCU.

“TYPEB” decryption process: the HHCU receives parameter “B” and stores into RAM 203, then converts into original signal, and terminates this operation if the signal is invalid after decryption.

“TYPEC” encryption process: the HHCU 2 converts parameter “B” in RAM 203 into encryption signal, and transmits to the main unit 1, “TYPEC” decryption process: the main unit 1 receives and converts parameter “B” in RAM 103 into original signal, and then terminates this operation if the signal is invalid after decryption.

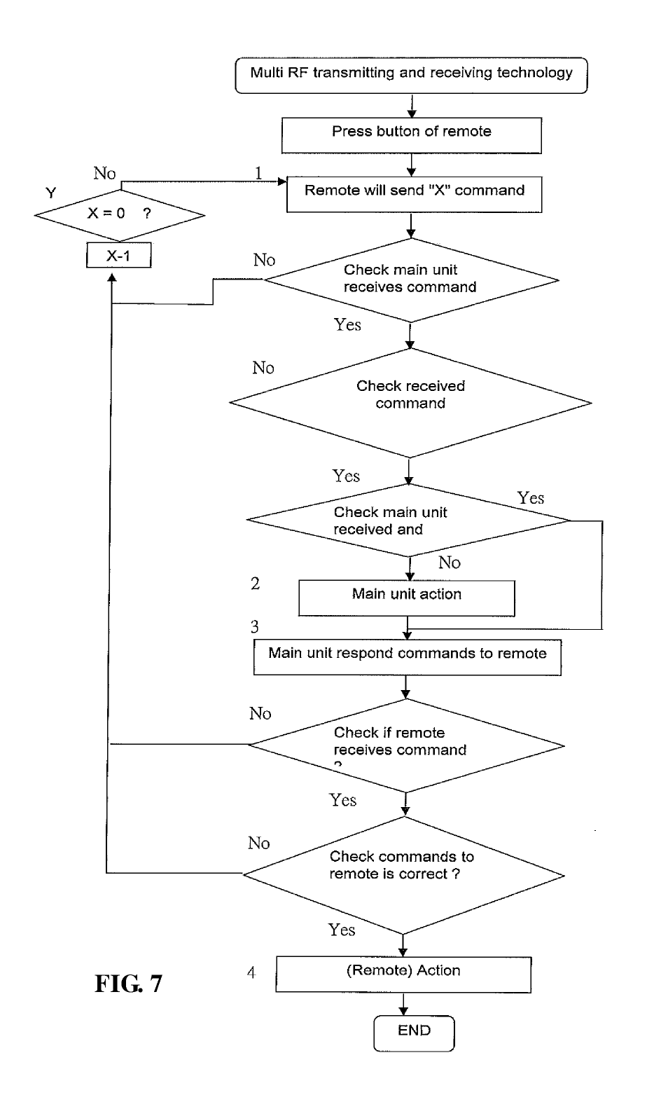

FIG. 7 of present invention depicts a process chart of a preferred embodiment of the present invention showing multiple RF transmission receiving technology between the main unit and HHCU; in addition to the method of searching optimized frequency for effective signal transmission between the main unit 1 and HHCU 2, an innovative, multiple RF transmission receiving technology is applied to realize highly stable signal transmission in the following steps:
Step 1. in normal cases, the signal mode is converted into RX mode waiting for feedback signal of the main unit once the HHCU transmits RF signal; in such case, the main unit sends back RF signal to the HHCU after receiving signal from it, and the HHCU will also receive signal from the main unit;
Step 2. (a) as shown in blocks 1˜2, in the case of adjacent channel interference which has led to failure of receiving signal by the main unit or interruption of communication due to error signal after the HHCU sends RE signal, the HHCU will send again RE signal and rebuild a communication channel; if the main unit cannot still receive the signal, the HHCU will continue to rebuild a communication channel until “X” number;
   (b) as shown in blocks 3˜4, in the case of adjacent channel interference which, although the main unit receives and sends back the signal to the HHCU, has led to failure of receiving signal by the HHCU or interruption of communication due to error signal after the HHCU sends RE signal, the HHCU will send again RE signal and rebuild a communication channel; if the HHCU cannot still receive the signal, it will also continue to rebuild a communication channel until “X” number;
   (c) as shown in blocks 5˜6, in the case of adjacent channel interference which has led to failure of receiving signal by the main unit or interruption of communication due to error signal after the HHCU sends RF signal, the HHCU will send again RF signal and rebuild a communication channel; if the main unit cannot still receive the signal, the HHCU will continue to rebuild a communication channel until “Y” number;
   (d) as shown in blocks 7˜8, in the case of adjacent channel interference which, although the main unit receives and sends back the signal to the HHCU, has led to failure of receiving signal by the HHCU or interruption of communication due to error signal after the HHCU sends RF signal, the HHCU will send again RF signal and rebuild a communication channel; if the HHCU cannot still receive the signal, it will also continue to rebuild a communication channel until “Y” number;

As shown in the figure, “X” and “Y” indicate the “number of multiple polling” in the multiple RF transmission receiving technology, which can be freely adjusted by the HHCU 2, a bigger number of polling means higher stability.

In addition to shortcomings of common remote control system such as: slow response and bigger power consumption, a “group tag encoding technology” has been designed and modified in the present invention, whereby the remote control system presents quick response, smaller power consumption and stronger resistance to interference.

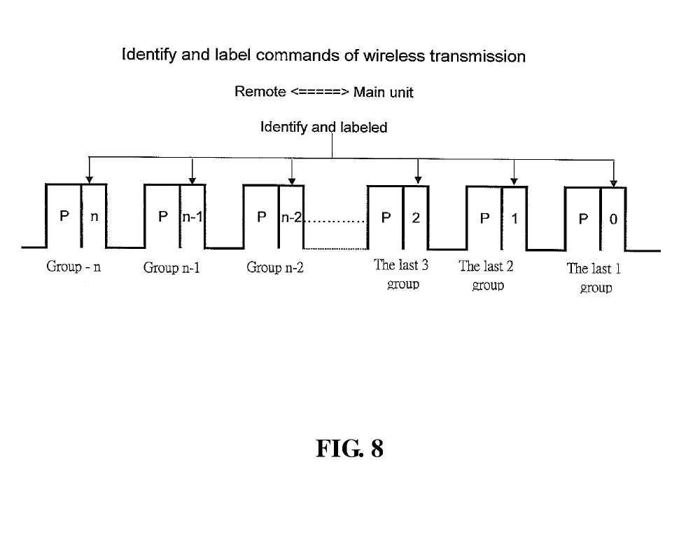

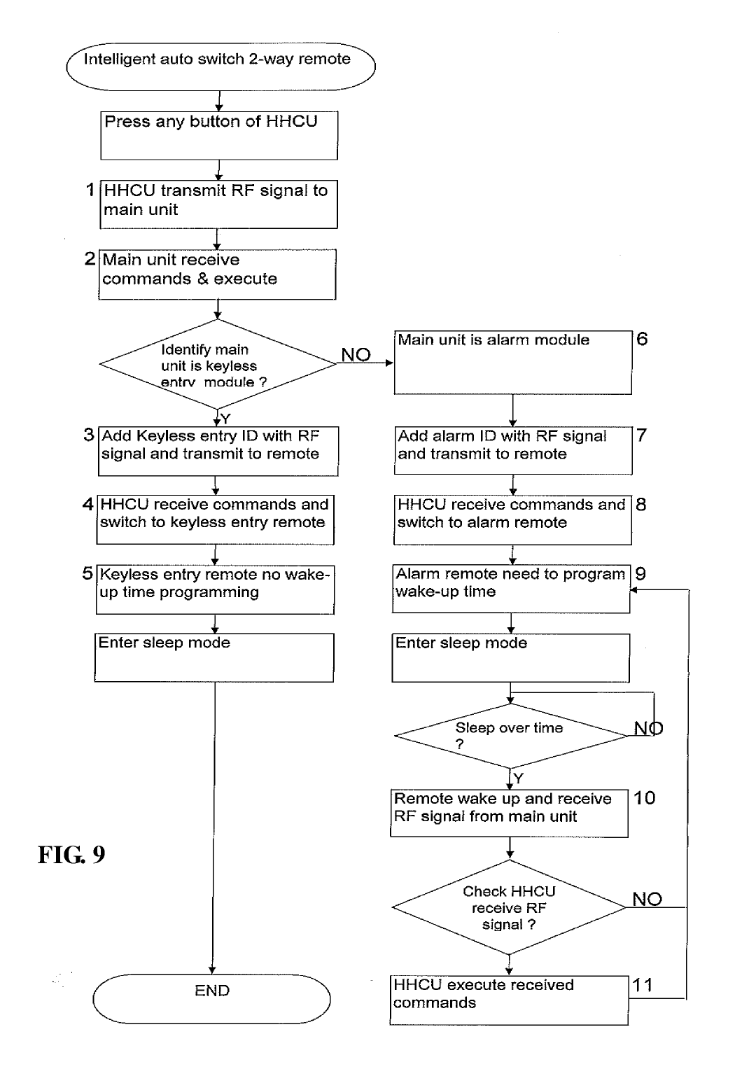

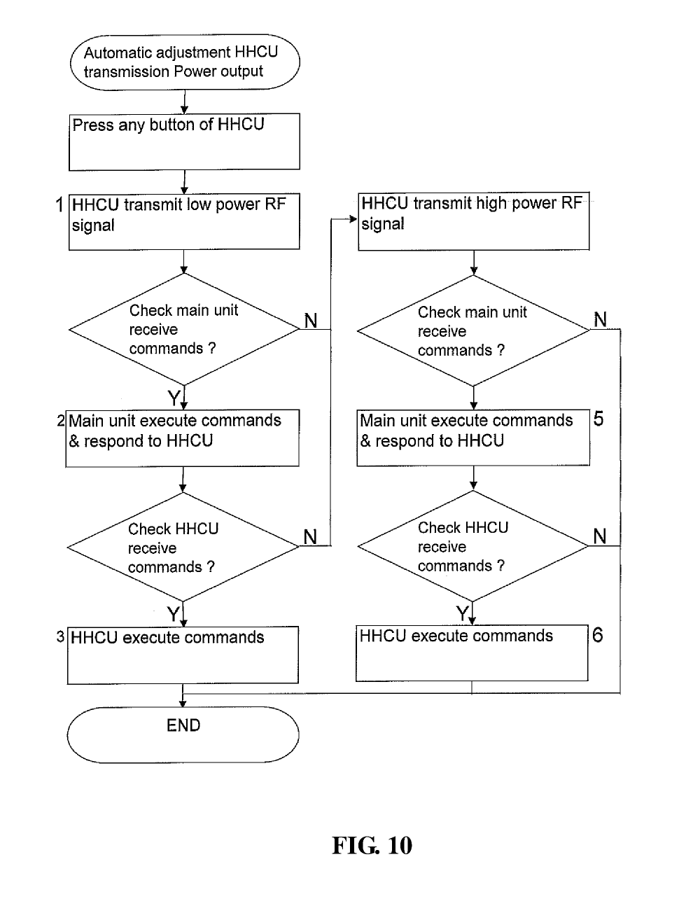

FIG. 8 depicts a schematic view of a preferred embodiment of the present invention showing a group tag encoding technology for RF transmission, whereby signals transmitted between the HHCU 2 and main unit 1 are provided with tag “n”, which can be adjusted freely. As shown in the figure, “P” indicates the content of the signal, “n” indicates the tag number; the key of the group tag encoding technology lies in that, “P” (the contents of every group are the same) transmitted between the HHCU 2 and main unit 1 is added with “n” (group tag), so as to distinguish the sequence and absolute position. To prevent both the HHCU 2 and main unit 1 from entering into the TX mode simultaneously, the main unit 1 must receive signals continuously until the HHCU 2 is not in a TX mode, and the TX mode is already converted into the RX mode after “a period of time upon end of signal transmission”; in such case, the transmission end of the main unit 1 is used to transmit signals, whilst the HHCU 2 must also receive signal continuously until the main unit 1 is not in a TX mode after “a period of time upon end of signal transmission”; with this “group tag encoding technology”, the receiving end can predict when the signal is ended according to tag “n”, if n=0, this indicates the signal is the signal of the last group, and the receiving end is not required to wait for “a period of time upon end of signal transmission”, but required to be converted immediately into TX mode for signal transmission; the transmission end is also converted immediately into RX mode after transmitting the signals in last group; so, the signal response becomes more quick and sensitive no matter the HHCU 2 or the main unit 1 is receiving or transmission end.

Secondly, larger power consumption is required no matter the HHCU 2 or the main unit 1 is at RX or TX mode, especially for the HHCU 2 with the battery as the power supply. Thus, the power consumption can be reduced by shortening the signal transmission time, without need of waiting time for a quick response.

In addition, if the signals are interrupted or even damaged partially during the transmission process, the receiving end may convert into a TX mode by misjudging as “a period of time upon end of signal transmission”; however, both ends are in a TX mode, leading to failure of normal system operation. After using the “group tag encoding technology”, the receiving end may judge which groups of signals are interrupted according to the received signal tag “n”, or when are the signals ended? This could avoid failure of normal system operation and increase the operational stability of remote control system.

In addition, present invention combines four common remote control function module into one remote control system and with the automatic module switch feature in the main unit to allow the users the ease to employee these function modules with a single HHCU. These four function modules are: keyless entry function module, alarm module, keyless entry-remote start module, and alarm-remote start module. A preferred embodiment of the present invention may comprising: a main unit 1 and a HHCU 2, wherein a module ID for each function module is include in the main unit 1 and HHCU 2. When the HHCU 2 communicates with the main unit 1, main unit 1 sends a particular module ID to the HHCU 2 and then when HHCU 2 receives the module ID, HHCU 2 automatically switch to the corresponding function module with the main unit 1. Hence, to allow a single HHCU 2 to be used for different function module main unit 1.

Referring to FIG. 9 an automatic module switch schematic chart between the main unit 1 and HHCU 2 in a preferred embodiment of the present invention:

Step 1: as depicted in block 1˜2 of FIG. 9 of present invention, HHCU 2 sends a high RF signal to main unit 1, main unit 1 executes corresponding function after the RF signal is received.

Step 2: (a) as depicted in block 3˜5 of FIG. 9 of present invention, if the main unit 1 is a keyless entry function unit, main unit 1 sends back a high RF signal included with a keyless entry module ID to the HHCU 2. When the HHCU 2 receives the high RF signal with a keyless entry module ID, a CPU 201 in the HHCU 2 switches the HHCU 2 into a keyless entry function module remote control unit and saves this setting in its ROM 203. And then, main unit 1, without setting sleep time, enters into sleep mode to minimize power consumption.
(b) as depicted in block 6˜11 of FIG. 9 of present invention, if the main unit 1 is an alarm function unit, main unit 1 sends back a high RF signal included with an alarm module ID to the HHCU 2. When the HHCU 2 receives the high RF signal with an alarm module ID, a CPU 201 in the HHCU 2 switches the HHCU 2 into an alarm function module remote control unit and saves this setting in its ROM 203. And then, HHCU 2 sets a sleep time of a few seconds and enters into sleep mode; main unit 1 also enters into sleep mode at this stage. When the sleep time expires, HHCU 2 awakes the main unit 1 by sending a RF signal and detects for any abnormal activities, such as door trigger, trunk trigger, shock trigger, and etc. HHCU 2 then executes corresponding function. If no abnormal activities are detected in main unit 1, HHCU 2 sets a sleep time of a few seconds and enters into sleep mode and so on and on in a repeated cycle.

Furthermore, present invention includes an automatic power output adjustment function method in corresponding to the distance range between the main unit 1 and HHCU 2. When in close range, a low power RF signal is transmitted and in long range a high power RF signal is transmitted. The following describes the automatic power adjustment function method:
(1) when the user presses the function key on the HHCU, the HHCU first transmits a low power RF signal to main unit. If the distance between HHCU and main unit is close, the HHCU will immediately receives a responding signal from the main unit, and thus completes the communication.
(2) when the user presses the function key on the HHCU, the HHCU first transmits a low power RF signal to main unit. If the HHCU does not immediately receives a responding signal from the main unit, HHCU will then re-transmit a high power RF signal to main unit (this means the range between the HHCU and main unit is greater).
(3) A close range may be: HHCU and main unit are within 100M apart. A long range may be: HHCU and main unit are over 100M apart.
(4) Typically, about 80% of use are within 100M range, 20% are of use are over 100M range. Hence, this function will minimize the power consumption and prolong the battery's life. In addition, this function will help to avoid remote control failure due to RF signal being too strong.

Referring to FIG. 10, an automatic power output adjustment function method schematic flow chart of a preferred embodiment of present invention: an automatic power output adjustment function method for a remote control system to allow main unit 1 and HHCU 2 when in close range transmit low power RF signals to reduce signal interference and to increase signal stability. In addition, to include power output adjustment mean that depends on the distance range between the main unit 1 and HHCU 2, to automatically adjust the power output rate of HHCU 2 when transmitting RF signals. When in close range, power output rate is low; and when in long range, power output is greater to achieve signal stability and at the same time, reduce power consumption. Typically, 80% of HHCU 2 use are within 10014 from the main unit 1, 20% of HHCU 2 use are over 100 M from the main unit 1. Hence, the present invention can significantly reduce power consumption and prolong battery life. In a preferred embodiment of the present invention:

Step 1: under normal operation, HHCU 2 transmits a high RF signal to main unit 1 and awaits a responding signal from main unit 1; when the main unit 1 receives a high RF signal from HHCU 2, main unit 1 then sends back a responding high RF signal back to HHCU 2; HHCU 2 receives a responding high RF signal from main unit 1 and completes the process.

Step 2: (a) as depicted in block 1˜3 of FIG. 10 of present invention, when HHCU 2 and main unit 1 are in close range, HHCU 2 first sends a low power high RF signal; after main unit 1 receives and processes said signal, main unit 1 then sends back a responding high RF signal back to HHCU 2, once the HHCU 2 receives the responding signal HHCU 2 then executes the signal function and completes the process. When the HHCU 2 and main unit 1 are in long range, the main unit 1 may not receive the signal HHCU 2 transmits or HHCU 2 does not receive the responding signal main unit 1 transmits. When one of these happens, the HHCU 2 will automatically increases power output and re-sends the signal to main unit 1.
(b) as depicted in block 4˜6 of FIG. 10 of present invention, when HHCU 2 and main unit 1 are in long range, HHCU 2 will transmit a high power high RF signal, when main unit 1 receives the signal, main unit 1 processes the said signal function and sends a responding signal back to HHCU 2, once the HHCU 2 receives the responding signal HHCU 2 then executes the signal function and completes the process.

To sum up, the remote control system of the present invention along with its anti-interference and anti-piracy methods for improved stability of RF signals as well as group tag encoding technology could be applied individually or collectively into the remote control system to meet the user demands in a broad range of applications.

Although the invention has been explained in relation to its preferred embodiment, it is to be understood that many other possible modifications and variations can be made without departing from the spirit and scope of the invention as hereinafter claimed.

1. Anti-interference and anti-piracy methods for improving stability of radio Signals for two-way remote control system comprising:
a main unit, mounted onto the vehicle for two-way wireless transmission to receive the required functional signals, implement the respective functions and send feedback signals; it consists of: a control unit, including: CPU, ROM, RAM and EEPROM; a TRU, mounted onto the vehicle for transmitting and receiving signals; the control unit is set to enable TRU to search automatically the interference-minimum frequency;
a HHCU, used to permit the main unit to perform multiple functions within effective range, receive the feedback signals from the main unit and display the implementation status after decryption; it consists of: a control unit, including: CPU, ROM, RAM and EEPROM; a TRX module, which mates automatically frequency with TRU on the vehicle.

2. The anti-interference and anti-piracy methods for improving stability of radio Signals for two-way remote control system as claimed in claim 1, wherein the main unit is provided with a power regulator for supplying stable power.

3. The anti-interference and anti-piracy methods for improving stability of radio Signals for two-way remote control system as claimed in claim 1, wherein the main unit is provided with a data bus interface connecting peripheral equipments.

4. The anti-interference and anti-piracy methods for improving stability of radio Signals for two-way remote control system as claimed in claim 1, wherein the HHCU is provided with a power regulator and power detector for supplying stable power.

5. An anti-interference method for the remote control system, comprising:
a main unit is used to search automatically RF band, and divide the frequencies therein into “n” blocks of the same size, so that every block contains the frequencies of the same quantity;
the onboard TRU is used to, at a fixed interval, conduct intensity calculation and weighting of the frequencies within all blocks, so as to find out the interference-minimum frequency and send a signal to provide a mating frequency for TRX module of the HHCU.

6. The anti-interference method as claimed in claim 5, wherein the intensity of frequency is calculated by weighted scoring.

7. The anti-interference method for remote control system as claimed in claim 5, wherein a back-up channel is designed to ensure frequency synchronization between the main unit and HHCU.

8. An interactive encryption method for remote control system, comprising:
the HHCU is used to transmit the encryption signal firstly added with parameter “A” to the main unit;
the main unit receives and decrypts the signal according to parameter “A”, and then feeds back the encryption signal firstly added with parameter “B”;
the HHCU receives and decrypts the fed back encryption signal according to parameter “B”, then transmits the encryption signal generated secondly by parameter “B”, but without need of transmitting parameter “B”;
the main unit receives and decrypts the signal according to parameter “B”, which refers to the functional action to be implemented by the main unit as required by the HHCU; after completion of implementation, the main unit sends back to the HHCU.

9. The interactive encryption method for remote control system as claimed in claim 8, wherein parameter “A” is “TYPEA” encryption signal generated randomly by CPU in the HHCU.

10. The interactive encryption method for remote control system as claimed in claim 8, wherein parameter “B” is “TYPEB” encryption signal generated randomly by CPU in the main unit.

11. The interactive encryption method for remote control system as claimed in claim 8, wherein “TYPEC” encryption signal can be generated from parameter “B” by CPU in the HHCU.

12. The interactive encryption method for remote control system as claimed in claim 8, wherein said method also includes: the signals transmitted between the HHCU and main unit are provided with tag “n”; so “P” indicates the content of the signal, “n” indicates the tag number; so, “P” transmitted between the HHCU and main unit is added with “n”, so as to distinguish the sequence and absolute position, enabling the receiving end to predict when the signal is ended according to tag “n”.

13. The interactive encryption method for remote control system as claimed in claim 8, wherein said interactive encryption method also encompasses an anti-interference method defined in claim 5.

14. A method of improving RF signal stability for the remote control system, whereby the HHCU continues to transmit RF signals of “X” number to the main unit in the following cases:
(a) in the case of channel interference which has led to failure of receiving signal by the main unit or interruption of communication due to error signal after the HHCU sends RE signal, the HHCU will send again RE signal and rebuild a communication channel; if the main unit cannot still receive the signal, the HHCU will continue to rebuild a communication channel until “X” number;
(b) in the case of channel interference which, although the main unit receives and sends back the signal to the HHCU, has led to failure of receiving signal by the HHCU or interruption of communication due to error signal, the HHCU will send again RE signal and rebuild a communication channel; if the HHCU cannot still receive the signal, it will also continue to rebuild a communication channel until “X” number.

15. The method for improving RF signal stability for the remote control system as claimed in claim 14, wherein “X” indicates the “number of multiple polling” in the multiple RF transmission receiving technology, which can be freely adjusted by the HHCU 2, a bigger number of polling means higher stability.

16. The method for improving RF signal stability for the remote control system as claimed in claim 14, wherein said method also encompasses an anti-interference method claimed in claim 5.

17. The method for improving RF signal stability for the remote control system as claimed in claim 16, wherein said method also encompasses an interactive encryption method claimed in claim 8.

18. A multiple function module method for remote control system comprising following steps:
(1) to include at least one of remote control function system module in a HHCU and a main unit;
(2) to assign a module ID to each of the said remote control function system and to include said ID in the HHCU and main unit RF signal;
(3) to transmit said RF signal with module ID from the HHCU to the main unit to allow said main unit to execute corresponding function;
(4) to transmit a responding RF signal with a module ID from the main unit to said HHCU; and
(5) said HHCU automatically switch to the function module corresponding to the module ID included in the said RF signal.

19. The multiple function module method for remote control system as claimed in claim 18, wherein said remote control function system module comprises keyless entry function module, keyless entry-remote start function module, remote start function module, alarm function module and alarm-remote start function module.

20. An automatic power output adjustment function and minimize power consumption method for remote control system comprises the following steps:
(1) to transmit a low power RF signal from a HHCU to a main unit; if said main unit receives the RF signal from HHCU, said main unit executes the corresponding function and sends a responding RF signal back to the HHCU; and
(2) when said main unit does not receive RF signal from the HHCU or the HHCU does not receive a responding signal from the said main unit, the HHCU increase the power output and re-sends the signal to main unit.

21. The automatic power output adjustment function and minimize power consumption method for remote control system as claimed in claim 20, wherein when said HHCU and main unit is within 100 meter apart, a low power output RF signal is transmitted; whereas, when said HHCU and main unit is over 100 meter apart, a high power output RF signal is transmitted.
